(19) United States
(12) Patent Application Publication
(10) Pub. No.: US 2026/0332486 A1
(43) Pub. Date: Oct. 22, 2026

(54) TASK SPECIFIC MEASURMENT INPUT OPTIMIZATION

(71) Applicant: Nokia Technologies Oy, Espoo (FI)

(72) Inventors: Shu Qiang SUN, Chengdu (CN); Haitao TANG, Espoo (FI); Stephen MWANJE, Munich (DE)

(21) Appl. No.: 18/997,950

(22) PCT Filed: Aug. 5, 2022
(86) PCT No.: PCT/CN2022/110636

§ 371 Date: Jan. 23, 2025

(51) Int. Cl. H04L 41/16; G06F 9/48; G06N 20/00

(52) U.S. Cl. CPC H04L 41/16; G06F 9/4843; G06N 20/00

(57) ABSTRACT

Example embodiments of the present disclosure relate to task specific measurement data optimization. A first device receives, from a second device, a request for input-output correlation analytics with respect to a data analytics task. In response to the request, the first device performs the input-output correlation analytics on a set of measurement inputs and a target output of the data analytics task, and transmits to the second device, a response indicating a result of the input-output correlation analytics.

### FIELD

Various example embodiments of the present disclosure generally relate to the field of telecommunication and in particular, to methods, devices, apparatuses and computer readable storage medium for task specific measurement data optimization.

### BACKGROUND

Communication networks have been developed with the capability to support a variety of communication services, such as Internet of Things (IoT) and Enhanced Mobile Broadband (eMBB). The increasing flexibility of the networks to support services with diverse requirements may present operational and management challenges. Therefore, the networks management system can benefit from network data analytics for improving networks performance and efficiency to accommodate and support the diversity of services and requirements.

### SUMMARY

In a first aspect of the present disclosure, there is provided a first device. The first device comprises at least one processor; and at least one memory storing instructions that, when executed by the at least one processor, cause the first device at least to perform: receiving, from a second device, a request for input-output correlation analytics with respect to a data analytics task; in response to the request, performing the input-output correlation analytics on a set of measurement inputs and a target output of the data analytics task; and transmitting, to the second device, a response indicating a result of the input-output correlation analytics.

In a second aspect of the present disclosure, there is provided a second device. The second device comprises at least one processor; and at least one memory storing instructions that, when executed by the at least one processor, cause the second device at least to perform: transmitting, to a first device, a request for input-output correlation analytics with respect to a data analytics task, the data analytics task being configured to analyze a set of measurement inputs to generate a target output; and receiving, from the first device, a response indicating a result of the input-output correlation analytics on the set of measurement inputs and the target output.

In a third aspect of the present disclosure, there is provided a method. The method comprises: receiving, at a first device and from a second device, a request for input-output correlation analytics with respect to a data analytics task; in response to the request, performing the input-output correlation analytics on a set of measurement inputs and a target output of the data analytics task; and transmitting, to the second device, a response indicating a result of the input-output correlation analytics.

In a fourth aspect of the present disclosure, there is provided a method. The method comprises: transmitting, at a second device and to a first device, a request for input-output correlation analytics with respect to a data analytics task, the data analytics task being configured with a set of measurement inputs as input and to generate a target output; and receiving, from the first device, a response indicating a result of the input-output correlation analytics on the set of measurement inputs and the target output.

In a fifth aspect of the present disclosure, there is provided a first apparatus. The first apparatus comprises: means for receiving, from a second apparatus, a request for input-output correlation analytics with respect to a data analytics task; in response to the request, performing the input-output correlation analytics on a set of measurement input s and a target output of the data analytics task; and means for transmitting, to the second apparatus, a response indicating a result of the input-output correlation analytics.

In a sixth aspect of the present disclosure, there is provided a second apparatus. The second apparatus comprises: means for transmitting, to a first apparatus, a request for input-output correlation analytics with respect to a data analytics task, the data analytics task being configured with a set of measurement inputs as input and to generate a target output; and means for receiving, from the first apparatus, a response indicating a result of the input-output correlation analytics on the set of measurement inputs and the target output.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication system in which example embodiments of the present disclosure can be implemented;

FIG. 2 illustrates an illustrative environment in which some example embodiments of the present disclosure can be implemented;

FIG. 3 illustrates a signaling chart for communication according to some example embodiments of the present disclosure;

FIG. 4 illustrates a signaling chart for communication according to some further example embodiments of the present disclosure;

FIG. 5 illustrates a flowchart of a method implemented at a first device according to some example embodiments of the present disclosure;

FIG. 6 illustrates a flowchart of a method implemented at a second device according to some example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

### Example Environment

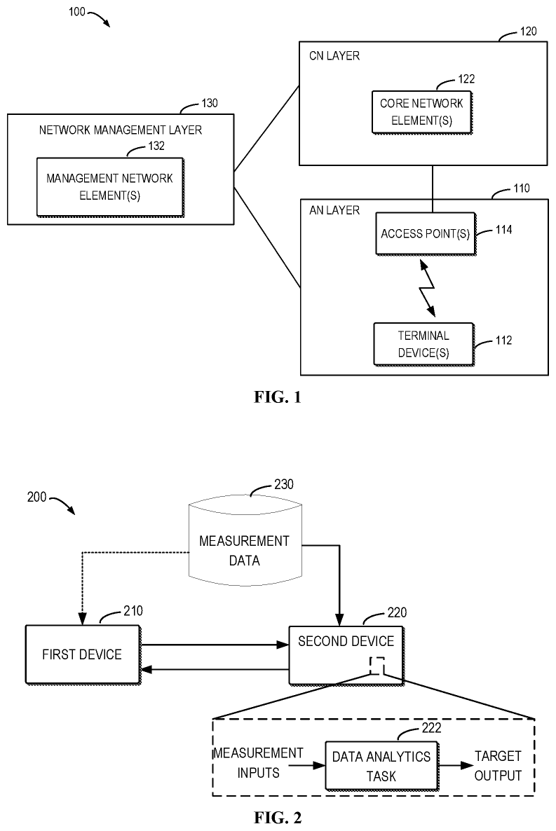

FIG. 1 illustrates an example communication system 100 in which example embodiments of the present disclosure can be implemented. It is to be understood that the elements shown in the communication system 100 are intended to represent main functions provided within the system. As such, the blocks shown in FIG. 1 reference specific elements in communication networks that provide these main functions. However, other network elements may be used to implement some or all of the main functions represented. Also, it is to be understood that not all functions of a communication network are depicted in FIG. 1. Rather, functions that facilitate an explanation of illustrative embodiments are represented. Further, the number of the elements shown in FIG. 1 is also for the purpose of illustrative only and there may be any number of elements.

Communications in the communication system 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As shown, the communication system 100 comprises an access network (AN) layer 110 which may include one or more radio access networks (RANs), a core network (CN) layer 120, and a network management layer 130. The AN layer 110 may comprise one or more terminal devices 112 that communicates with an access point(s) 114. The access point 114 is illustratively part of an access network of the communication system 100. Such an access network may comprise, for example, a 5G System having a plurality of base stations and one or more associated radio network control functions. The base stations and radio network control functions may be logically separate entities, but in a given embodiment may be implemented in the same physical network element, such as, for example, a base station router or femto cellular access point.

The AN layer 110 may connect with the CN layer 120. The CN layer 120 may comprise one or more core network elements 122. The CN layer 120 may be configured for access and mobility management, protection, registration management, connection management, reachability management, security context management, lawful intercept, and/or other network functions.

The network management layer 130 may communicate with elements in the CN layers 120 and/or the AN layer 110. The network management layer 130 may comprise one or more management network elements 132, and may be configured for higher layer of management in the communication system 100, including various aspects related to operation, administration and maintenance (OAM). The network management layer 130 may receive data from the CN layers 120 and/or the AN layer 110 for the purpose of analysis and network management.

In some example embodiments, the CN layers 120 and/or the network management layer 130 may be implemented according to a service-based architecture. The functionalities of some or all of the network elements may be managed and provisioned as respective services. Following the consumer-producer paradigm, a network element subscribing or consuming a service provided by another network element may be referred to as a “managed service consumer” or “MnS consumer” while a network element providing the subscribed or consumed service may be referred to as a “managed service producer” or “MnS producer.”

The communication networks are becoming increasingly complex, as new technologies, such as network densification, network slicing, beamforming, mmWave, MR-DC (multi-rate dual connectivity) and so on, are introduced to extend the capacity while reduce the latency in mobile communication to meet the requirements of various demanding applications. Some network elements may perform completed data analytics tasks. A data analytics tasks may process a set of measurement inputs collected from the communication network, to generate a target output.

In some example embodiments, to improve network performance and efficiency, the industry is looking for solutions with AI/ML technology to embed intelligence in the communication system and implement the required data analytics tasks. For example, it has been agreed to include the Model Inference function in the RAN node and the Model Training function in OAM. It is also identified that the input and output data needed to be collected by OAM to support AI/ML model training and evaluation for three use cases: network energy saving, load balancing, and mobility optimization. It is also approved to study measurement data collection to support RAN intelligence.

According to the AI/ML technology, a network element may rely on a computational logic or algorithm to analyze data in order to produce the desired statistics and/or predictions. Such logic or algorithms may be implemented as an Artificial Intelligence (AI)/Machine Learning (ML) model. As used herein, the term “ML model” or “AI model” represent logic or an algorithm that can be “trained” by data and human expert input as examples to replicate a decision an expert would make when provided that same information. In the following, “ML model” and “AI model” are used interchangeably, or sometimes may be referred to as AI/ML model.

Machine learning may generally involve two stages, including a training stage to train the ML model with training data and an inference stage to apply the trained ML model to generate an output for real-world input data. During the training stage, training data is run through an AI/ML model to derive the associated loss and adjust the parameterization of that AI/ML model based on the computed loss. During the inference stage, the real-world input data are processed by the ML model based on the model parameter values determined in the training stage.

### Work Principle and Example Signaling for Communication

A data analytics task usually takes measurement data as input to predict or generate a target output. In the network environment, as an example, a data analytics task is to predict a cell load. To execute this data analytics task, measurement data may be collected from a network device (e.g., an access point) for use. The target output of this task is the predicted load for a cell. The measurement inputs that may potentially be useful for the load prediction may, for example, include average downlink (DL) throughput, average uplink (UL) throughput, maximum user act buffer, DL latency, average active users in the cell, channel quality in the cell, and so on.

For a certain data analytics task, there may be a huge amount of measurement inputs collectable from a large scale of measurement data. Some measurement inputs are often highly corelated (linearly or non-linearly) with each other, or may have little correlation with the target output. For example, a measurement input may be an average or aggregation value of two or more other measurement inputs. Typically, either the individual measurement inputs or the averaged or aggregated measurement input can provide feature information to facilitate deriving of the target output. Giving redundant measurement inputs may not reduce the accuracy of prediction of the target output. However, taking all of those measurement inputs for analytics may not only waste the resource for executing the data analytics task, but also increase redundant workload for the network elements or the terminal devices to collect or calculate the redundant measurement inputs.

On the other hand, the means for implementing the data analytics task may be evolved gradually due to network changes, technology improvement, and so on. With such development, some measurement inputs may not have high contributions to the target output or some additional measurement inputs may need to be added. In the current communication system, such updates to measurement inputs of the data analytics task are not able to be timely discovered unless human intervention is involved.

According to some example embodiments of the present disclosure, there is provided a solution for task specific measurement input optimization. In this solution, a first device, per request, performs input-output correlation analytics on a set of measurement inputs and a target output of a data analytics task. The input-output correlation analytics may be requested by a second device which expects to evaluate the measurement inputs used for the data analytics task. The first device transmits a result of the input-output correlation analytics as a feedback to a second device issues the request. Through this solution, automatic analysis of input-output correlation analytics is enabled, to optimize measurement data for a specific data analytics task. There may be a desired tradeoff between the task performance and the resource and/or workload for task execution and measurement data collection.

Example embodiments of the present disclosure will be described in detail below with reference to the accompanying drawings.

Reference is first made to FIG. 2, which shows an illustrative environment 200 in which some example embodiments of the present disclosure can be implemented. In the environment 200, a first device 210 is configured to perform input-output correlation analytics, and a second device 220 is a requestor for input-output correlation analytics on a data analytics task 222. The first device 210 and/or the second device 220 may be part of a communication system, such as the communication system 100 in FIG. 1. In some example embodiments, the first device 210 and/or the second device 220 may comprise network elements in a CN layer, a network management layer, and/or access points in an AN layer.

The data analytics task 222 is configured to analyze a set of measurement inputs to generate a target output. The data analytics task 222 may rely on an association between the measurement inputs and the target output. Such an association may be represented as a computational logic or algorithm. In some example embodiments, a ML model may be used to implement the data analytics task 222.

Examples of the data analytics task 222 may include, for example, cell load predation, network element load, mobility prediction, communication prediction, and so on. The measurement inputs may include or may be calculated from measurement data 230, which is collected by network elements, by access points, by terminal devices, and/or from other sources. In some example embodiments, the measurement inputs may also be referred to as input data features, and the target output may be referred to as a target data feature.

The second device 220 is allowed to request for input-output correlation analytics on the data analytics task 222. In some example embodiments, the second device 220 may be a consumer or a producer of the data analytics task 222. In some example embodiments, according to a service-based architecture, the input-output correlation analytics may be provided as a managed service. In this case, the first device 210 may comprise an entity for a managed service producer which provides the service of input-output correlation analytics. The second service 220 may comprise an entity for a managed service consumer which consumes the service of input-output correlation analytics.

In some example embodiments, in addition to the input-output correlation analytics, the first device 210 may provide other functionalities, such as some functionalities related to the data analytics task 222. For example, the first device 210 may provide a service for training a ML model for implementing the data analytics task 222. In this case, the first device 210 may have access to the measurement data 230 which are used to determine the measurement inputs for the data analytics task 222. In some examples, the second device 220 may comprise a consumer of the data analytics task 222, such as a consumer which utilizes the trained ML model.

In some example embodiments, the service of input-output correlation analytics may be provisioned as a dedicated service at the first device 210. For example, the first device 210 may be considered as a managed service producer for the data analytics task 222. In this case, the second device 220 may comprise any entity that is allowed to trigger input-output correlation analytics for the data analytics task 222, for example, a consumer or producer of the data analytics task 222.

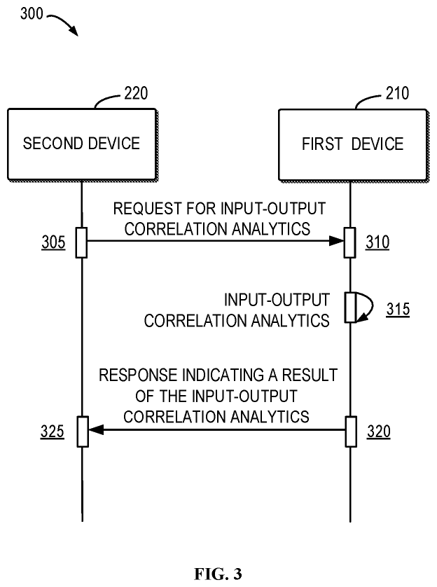

To better illustrate the signaling between the first device 210 and the second device 220 with respect to the input-output correlation analytics, reference is further made to FIG. 3. FIG. 3 shows a signaling chart 300 for communication between the first device 210 and the second device 220 in FIG. 2.

The second device 220 transmits 305 a request for input-output correlation analytics with respect to the data analytics task 222. The first device 210 receives 310 a request for input-output correlation analytics from the second device 220.

In some example embodiments, the second device 220 may also be configured for provisioning a service of the data analytics task, for example, provisioning a trained ML model for implementing the data analytics task 222. In this case, the second device 220 may request for initiating new training on a ML model for the data analytics task 222, for example, to fine tune a currently used ML model or to reconstruct a new ML model. In some example embodiments, the request for input-output correlation analytics may be received in association with a request for initiating training of a ML model for implementing the data analytics task 222.

In some example embodiments, the request for input-output correlation analytics may comprise an information element (IE), referred to as a controlling IE. In some example embodiments, the controlling IE may comprise a managed object instance (MOI). The IE may comprise attributes related to the input-output correlation analytics.

Depending on the service provided by the first device 210, the second device 220 may transmit a request for creating a MOI for a service of the data analytics task 222 (e.g., for training a ML model for the task), or creating a MOI for a service of input-output correlation analytics. In the case of creating a MOI, a request for the input-output correlation analytics may be considered as an additional attribute added to a MOI corresponding to training a ML model for the task, as in Table 1.

In Table 1, an attribute named “measurementDataCorrelationAnalytics” is added to attribute tables for an IE (i.e., MOI) of training the ML model. The support qualifier of the attribute named “measurementDataCorrelationAnalytics” is optional (“O”). In Table 1 and in following tables to be provided, “T” indicate a true flag, “F” indicate a false flag, a support qualifier indicating “O” means optional, a support qualifier indicating “M” means mandatory, and a support qualifier indicating “CM” means conditional mandatory.

In Table 1 and in following tables to be provided, the column “Support Qualifier” indicates whether the attribute is optional, mandatory, or optional mandatory to a consumer, which is the second device 220 in the example embodiments of the present disclosure; the column “isReadable” indicates whether the attribute is readable by the consumer; the column “isWritable” indicates whether the attribute is writable by the consumer; the column “isInvariant” indicate whether the attribute is a variable value; the column “isNotifyable” indicates whether the attribute can be notified to the consumer.

TABLE 1
Attributes

| | Support | | | | |
|---|---|---|---|---|---|
| Attribute name | Qualifier | isReadable | isWritable | isInvariant | isNotifyable |
| aIMLEntityId | M | T | T | F | T |
| candidateTraingDataSource | O | T | T | F | T |
| traingDataQualityScore | O | T | T | F | T |
| trainingRequestSource | M | T | T | F | T |
| requestStatus | M | T | T | F | T |
| expectedRuntimeContext | O | T | T | F | T |
| performanceRequirements | M | T | T | F | T |
| cancelRequest | O | T | T | F | T |
| suspendRequest | O | T | T | F | T |
| measurementDataCorrelationAnalytics | O | T | T | F | T |
| Attribute related to role | | | | | |

In some example embodiments, the request for input-output correlation analytics may be comprised a separate IE from the IE for training the ML model. The IE for the input-output correlation analytics will be further discussed below.

In some example embodiments, the second device 220 may be configured to implement a managed service for the input-output correlation analytics proposed herein. The first device 210 may be any entity that is allowed to initiate the input-output correlation analytics for the data analytics task 222.

In response to the request for input-output correlation analytics, the first device 210 performs 315 the input-output correlation analytics on the set of measurement inputs and the target output of the data analytics task 222.

As used herein, input-output correlation analytics is to analyze the set of measurement inputs that are currently used in the data analytics task 222, to determine a correlation relationship between the set of measurement inputs and the target output of the data analytics task 222, and/or a correlation relationship between the set of measurement inputs. A correlation relationship between a measurement input and the target output may indicate a contribution of the measurement input in deriving the target output. A correlation relationship between two measurement inputs may indicate a degree how the two measurements are correlated or relevant with each other. Sometimes the input-output correlation analytics may also be referred to as measurement data correlation analytics (MDCA).

From the perspective of efficiency, it is expected to filter out a subset of measurement inputs that have higher correlation to the target output and have lower correlation with each other. In some example embodiments, the purpose of the input-output correlation analytics to select such a subset of measurement inputs from the set of measurement inputs that are currently used for the data analytics task 222. In some example embodiments, the input-output correlation analytics may also be configured to determine whether there is one or more additional measurement inputs from raw measurement data which are highly correlated with the target output but are missed from the data analytics task 222.

In some example embodiments, the second device 220 may provide or indicate to the first device 210 the set of measurement inputs that are currently used for the data analytics task 222 and the target output. In some example embodiments, the first device 210 may have access to the measurement data 230 to obtain the set of measurement inputs. The first device 210 may perform analysis on the set of measurement inputs and the target output.

There are various technologies that can be applied for analyzing a correlation between input and output of a task, to reduce the number of input elements and/or discover new input element, especially in the case of machine learning. There is no limitation to the technologies applied at the first device 210 for the correlation analytics.

In some example embodiments, if the request for input-output correlation analytics is received together with a request for training a ML model for the data analytics task 222, the first device 210 may also orchestrate the training as configured in the request, by taking the set of measurement inputs as part of the training procedure. The training may be initiated as a separate process from the input-output correlation analytics, and the first device 210 may transmit a response to the second device 220 after the training is completed. In some examples, if the request is a request for creating a MOI, the first device 210 may instantiate a MOI for the training of the ML model (represented as “AIMLTrainingProcess MOI”). After the training is completed, the attributes of the MOI may be updated, and the first device 210 may notify the second device 220 about the updated MOI.

Upon completion of the input-output correlation analytics, the first device 210 transmits 320, to the second device, a response indicating a result of the input-output correlation analytics. Upon receiving 325 the response, in some example embodiments, the second device 220 may determine whether or not to update the set of measurement inputs that are used as input to the data analytics task.

In some example embodiments, the result of the input-output correlation analytics may indicate a set of recommended measurement inputs for the data analytics task 222 that are determined from the input-output correlation analytics. The set of recommended measurement inputs may be determined as having a correlation higher than a threshold with the target output. Thus, those measurement inputs are believed to be more relevant to the target output.

In some example embodiments, the set of recommended measurement inputs may comprise a subset of the measurement inputs that are currently used for the data analytics task 222. In those embodiments, the input-output correlation analytics is to reduce the number of measurement inputs used in the data analytics task 222, so as to reduce workload for collecting the measurement data and the resource consumed in running the task. In some cases, using less measurement inputs may lead to some performance loss on the data analytics task 222, but the performance loss may be acceptable as compared with the burden of using the original set of measurement inputs.

In some example embodiments, the set of recommended measurement inputs may comprise one or more additional measurement inputs that are recommended to be added as input of the data analytics task 222. The additional measurement inputs may be determined as having a correlation higher than a threshold with the target output. The discovery of the new measurement inputs may depend on the algorithms applied for the input-output correlation analytics based on raw measurement data that are collectable by network elements and/or terminal devices.

With the set of recommended measurement inputs notified by the first device 210, the second device 220 may confirm whether or not to replace the set of original measurement inputs with the set of recommended measurement inputs. In some example embodiments, it may be the first device 210 which is allowed to confirm whether or not use the set of recommended measurement inputs. In this case, those recommended measurement inputs may also be notified to the second device 220, so as to facilitate running of the data analytics task 222 with the new set of recommended measurement inputs.

In some example embodiments, the result of the input-output correlation analytics may indicate a completion status of the input-output correlation analytics, for example, a success or failure result of the input-output correlation analytics. If the first device 210 is able to determine the set of recommended measurement inputs, the completion status may indicate a success result. Otherwise, if the first device 210 is not able to recommend measurement inputs for the data analytics task 222, the completion status may indicate a failure result. In some example embodiments, the completion status may specifically indicate a reason causing the failure. For example, the input-output correlation analytics may be failed to high performance impact (higher than a predetermined performance impact tolerance) if one or more measurement inputs are filtered out. There may be other failure reasons and the first device 210 may specifically indicate those reasons to the second device 220.

In some example embodiments, considering that discarding some measurement inputs may lead to performance loss, the second device 220 may indicate, to the first device 210, a performance impact tolerance of the data analytics task 222. The indication may be comprised in the request for input-output correlation analytics. The performance impact tolerance may be a performance requirement for the input-output correlation analytics. In some example embodiments, the performance impact tolerance may be provided in a percentage form or other suitable form, to require a performance impact of the data analytics task 222 with the set of recommended measurement inputs is within a predetermined range, for example, a predetermined performance loss as compared with the performance of the data analytics task 222 using the current set of measurement inputs. For example, a performance impact tolerance of “5%” indicates that the performance for the data analytics task 222 with the set of recommended measurement inputs is not worse than 5% of the performance of the data analytics task 222 using the current set of measurement inputs.

With the performance impact tolerance indicated, controlled performance impact is enabled during the input-output correlation analytics. The first device 210 may perform the input-output correlation analytics by taking the performance impact tolerance into account. The resulting set of recommended measurement inputs may not cause a high performance impact beyond the performance impact tolerance. In some example embodiments, the result of the input-output correlation analytics indicate a resulting performance impact by replacing the set of measurement inputs with the set of recommended measurement inputs as input of the tata analytics task. The first device 210 may select the set of recommended measurement inputs to allow the resulting performance impact being within the performance impact tolerance.

It should be appreciated that in some example embodiments, the performance impact tolerance may not be indicated by the second device 220 per request and a predetermined or preconfigured performance impact tolerance may be applied when the first device 210 performs the input-output correlation analytics.

In some example embodiments, renewing the input-output correlation analytics as the time progresses may be beneficial since the correlation relationships between the measurement inputs and between the measurement inputs and the target output may change as the time progresses. The changes of correlation relationships may be caused by the network environment changes (for example, network element upgrading), and/or other reasons.

In some example embodiments, the second device 220 may indicate the first device 210 to perform regular input-output correlation analytics. The indication may be comprised in the request for input-output correlation analytics. For example, the request for input-output correlation analytics further indicate a scheduling status of regular input-output correlation analytics, to indicate enablement or disablement of regular input-output correlation analytics. When the regular input-output correlation analytics is enabled, the first device 210 may perform the input-output correlation analytics regularly, according to a predetermined cycle. The regular input-output correlation analytics may also be referred to as “scheduled input-output correlation analytics” or “scheduled MDCA.”

In some example embodiments, the predetermined cycle for the regular input-output correlation analytics may be configured by the second device 220, for example, may be indicated in the request for input-output correlation analytics. For example, the second device 220 may indicate how frequent the input-output correlation analytics is performed, e.g., every weekly, or monthly. In some example embodiments, the second device 220 may further indicate a start time for input-output correlation analytics, to indicate when to start one round of input-output correlation analytics. For example, the second device 220 may indicate the input-output correlation analytics to be start in middle-night, in order to balance the computing load.

In some example embodiments, if regular input-output correlation analytics is enabled at the first device 210, the second device 220 may be able to control suspending, resuming, and/or terminating of the regular input-output correlation analytics.

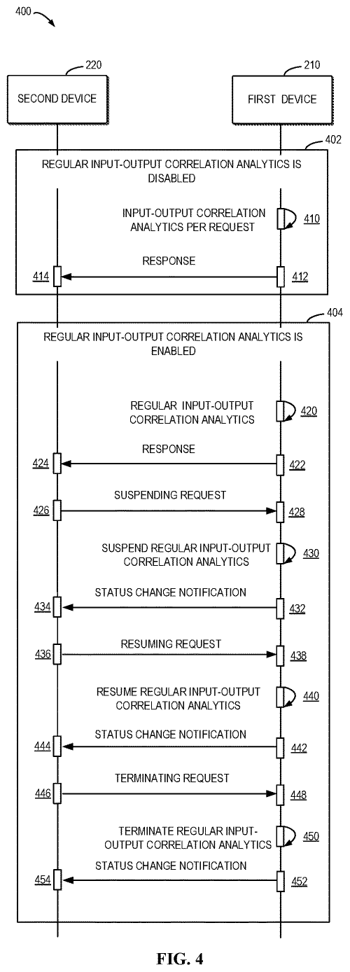

Some example embodiments related to the cases where regular input-output correlation analytics is disabled and enabled will be discussed in detail below with reference to FIG. 4. In the following, it is first introduced some example embodiments related to an IE defined for requesting and responding for input-output correlation analytics.

In has been discussed above some examples of indication in the request for input-output correlation analytics and the corresponding response. In some example embodiments, an IE may be defined for carry the request and/or the response. The IE may be configured with one or more attributes to indicate different information. In some examples, the IE may, for example, include a MOI.

Specifically, in some example embodiments, the IE may be configured with an attribute to indicate enablement or disablement of regular input-output correlation analytics (represented as “scheduledMDCA”). This attribute may be written by the second device 220 in the request forinput-output correlation analytics, to indicate whether or not the regular input-output correlation analytics is enabled.

In some example embodiments, the IE may be configured with an attribute to indicate a true or false status of regular input-output correlation analytics (represented as “scheduledMDCAFlag”). For example, this attribute may be set with a true status to indicate enablement of regular input-output correlation analytics, or a false status to indicate the disablement. In some examples, this attribute may be set by default with a false status. This attribute may be written by the second device 220 in the request forinput-output correlation analytics.

In some example embodiments, the IE may be configured with an attribute to indicate a performance impact tolerance of the data analytics task 222 (represented as “modelPerformanceImpactTolarance”), and may be written by the second device 220 in the request forinput-output correlation analytics.

In some example embodiments, the IE may be configured with an attribute to indicate a success or failure result of the input-output correlation analytics (represented as “mDCAResult”). This attribute may be written by the first device 210 in the response for the request of input-output correlation analytics.

In some example embodiments, the IE may be configured with an attribute to indicate a set of recommended measurement inputs correlated to the target output (represented as “candidateCorrelatedMeasurementData”). This attribute may provide address(es) of the recommended measurement inputs generated from the input-output correlation analytics. This attribute may be written by the first device 210 in the response for the request of input-output correlation analytics. In some examples, the attribute “candidateCorrelatedMeasurementData” may be present in the IE in a condition that the attribute “mDCAResult” indicate a success result of the input-output correlation analytics.

In some example embodiments, the IE may be configured with an attribute to indicate a resulting performance impact by applying the set of recommended measurement inputs for the data analytics task (represented as “mDCAPerformanceImpactResult”). This attribute may be written by the first device 210 in the response for the request of input-output correlation analytics.

In some examples, if the regular input-output correlation analytics is enabled, the attributes “candidateCorrelatedMeasurementData” and “mDCAPerformanceImpactResult” may be updated and indicate to the second device 220 if one round of input-output correlation analytics achieves a better result, for example, a set of recommended measurement inputs that lead to less performance impact or more performance gain.

The attributes in the IE are summarized in below Table 2.

TABLE 2
Attributes

| | Support | | | | |
|---|---|---|---|---|---|
| Attribute name | Qualifier | isReadable | isWritable | isInvariant | isNotifyable |
| candidateCorrelatedMeasurementData | CM | T | F | F | T |
| modelPerformanceImpactTolarance | M | T | T | F | T |
| mDCAResult | M | T | F | F | T |
| mDCAPerformanceImpactResult | O | T | F | F | T |
| scheduledMDCAFlag | O | T | T | F | T |
| scheduledMDCA | O | T | T | F | T |

From Table 2 and as discussed above, the attributes “modelPerformanceImpactTolarance,” “scheduledMDCAFlag” and “scheduledMDCA” are writable by the second device 220 and thus those attributes may be assigned with respective attribute values in the IE comprised in the request for input-output correlation analytics. The attributes “candidateCorrelatedMeasurementData,” “mDCAResult” and “mDCAPerformanceImpactResult” are writable by the first device 210 but also readable by the second device 220. Thus, those attributes may be assigned with respective attribute values in the IE comprised in the response sent to the second device 220.

In addition, as included in Table 2, the support qualifier for the attribute “candidateCorrelatedMeasurementData” is optional mandatory, subjecting to some constraint. The attribute constraint for the attribute “candidateCorrelatedMeasurementData” is provided in below Table 3.

TABLE 3
Attribute constraints

| Name | Definition |
|---|---|
| candidateCorrelatedMeasurementData | Condition: The value of |
| Support Qualifier | mDCAResult attribute is |
| | SUCCESSFUL_WITH_{—} |
| | MD_GENERATED. |

In some example embodiments, the attribute “scheduledMDCA”, which indicates enablement or disablement of regular input-output correlation analytics, may further comprise one or more sub-attributes related to the regular input-output correlation analytics. In some example embodiments, the attribute “scheduledMDCA” may comprise a sub-attribute to indicate cycle of the regular input-output correlation analytics, represented as “correlationAnalyticsCycle.” The attribute “scheduledMDCA” may additionally or alternatively comprises a sub-attribute to indicate a start time of the regular input-output correlation analytics, represented as “startTime.” The attribute “scheduledMDCA” may additionally or alternatively comprises a sub-attribute to indicate a scheduling status of the regular input-output correlation analytics “represented as “schedulingStatus.” The scheduling status may be selected from a running status or a suspended status.

The sub-attributes for the attribute “scheduledMDCA” are summarized in below Table 4 (indicate as “attributes” here).

TABLE 4
Attributes of scheduledMDCA

| | Support | | | | |
|---|---|---|---|---|---|
| Attribute name | Qualifier | isReadable | isWritable | isInvariant | isNotifyable |
| correlationAnalyticsCycle | M | T | T | F | F |
| startTime | O | T | T | F | F |
| schedulingStatus | M | T | T | F | F |

It would be appreciated that although some example indications in the request for input-output correlation analytics and the response are discussed in the above, there may be other or different indications to be included in the request and/or the response as required.

FIG. 4 illustrates a signaling chart 400 for communication according to some further example embodiments of the present disclosure. Reference is made to FIG. 4 to illustrate some example embodiments of disablement and enablement of regular input-output correlation analytics. The signaling chart 400 may be considered as some example embodiments related to the operations at 315, 320, and 325. The signaling chart 400 may include a signaling sub-chart 402 for the case where the regular input-output correlation analytics is not enabled, and a signaling chart 404 for the case where the regular input-output correlation analytics is enabled.

In the signaling chart 402, it is assumed that the first device 210 receives the request for input-output correlation analytics from the second device 120, indicating disablement of regular input-output correlation analytics. For example, the attribute of scheduling status “ScheduledMDCA” is not enabled. In response to such request, the first device 210 performs 410 one round of the input-output correlation analytics. That is, the input-output correlation analytics is performed per request.

The first device 210 transmits 412 a response indicating a result of the input-output correlation analytics to the second device 220. By receiving 414 the response, the second device 220 may be notified of a set of recommended measurement inputs for the data analytics task, a result of the input-output correlation analytics, a resulting performance impact, and/or other information.

In the signaling chart 404, it is assumed that the first device 210 receives the request for input-output correlation analytics from the second device 120, indicating enablement of regular input-output correlation analytics. For example, the attribute of “ScheduledMDCA” indicates enablement of regular input-output correlation analytics. In some example embodiments, the sub-attribute for scheduling status, “schedulingStatus” is set to indicate a running status of the regular input-output correlation analytics.

In response to such request, the first device 210 performs 420 regular input-output correlation analytics, for example, according to the predetermined cycle, which may be indicated by the request. In some example embodiments, the first device 210 may initiate each round of input-output correlation analytics at a start time indicated by the second device 220. In some example embodiments, the first device 210 may perform one or more rounds of input-output correlation analytics.

After a round of input-output correlation analytics is completed, the first device 210 transmits 422 a response indicating a result of the input-output correlation analytics to the second device 220. The second device 220 receives 424 a response about the result of the regular input-output correlation analytics.

In some cases, the second device 220 may decide to suspend the regular input-output correlation analytics. The second device 220 transmits 426 a suspending request for the regular input-output correlation analytics to the first device 210. In some example embodiments, the suspending request may be a request to modify a scheduling status of the regular input-output correlation analytics from a running status to a suspended status. For example, the second device 220 may transmit an IE with the attribute “ScheduledMDCA” set to indicate enablement of regular input-output correlation analytics but the sub-attribute for scheduling status, “schedulingStatus” is set to indicate a suspended status.

Upon receipt 428 of the suspending request, the first device 210 suspends 430 the regular input-output correlation analytics. Thus, no new round of input-output correlation analytics is initiated, and no new MDCA activity will be started.

In some example embodiments, the first device 210 may transmit 432, to the second device 220, a notification indicating that the regular input-output correlation analytics is suspended. This notification may be referred to as “status change notification” because it indicates the scheduling status of the regular input-output correlation analytics. By receiving 434 the notification, the second device 220 may determine that the regular input-output correlation analytics is suspended.

After some time from the suspending of the regular input-output correlation analytics, the second device 220 may decide to resume the regular input-output correlation analytics. The second device 220 transmits 436 a suspending request for the regular input-output correlation analytics to the first device 210. In some example embodiments, the second device 220 may transmit an IE with the “schedulingStatus” is set to indicate a runing status. In accordance with receipt 438 of the resuming request, the first device 210 resumes 440 the suspended regular input-output correlation analytics.

In some example embodiments, the first device 210 may transmit 442, to the second device 220, a status change notification indicating that the regular input-output correlation analytics is resumed. By receiving 444 the notification, the second device 220 may determine that the regular input-output correlation analytics is resumed.

The suspending and resuming of the regular input-output correlation analytics may be repeated as required by the second device 220.

In some cases, if the second device 220 determines that the input-output correlation analytics is not needed, it transmits 446 a terminating request to the first device 210. In some example embodiments, the second device 220 may transmit an IE with the attribute “ScheduledMDCA” set to indicate disablement of regular input-output correlation analytics.

In accordance with receipt 448 of the terminating request, the first device 210 terminates 450 the regular input-output correlation analytics. In some examples, if there is one round of input-output correlation analytics is ongoing, the first device 210 may wait until the input-output correlation analytics is completed and will not start further input-output correlation analytics.

In some example embodiments, the first device 210 may transmit 452, to the second device 220, a status change notification indicating that the regular input-output correlation analytics is terminated. By receiving 454 the notification, the second device 220 may determine that the regular input-output correlation analytics is terminated.

In some example embodiments, in the case that the solution for measurement data optimization is implemented in 3GPP communication systems, in “the 3rd Generation Partnership Project (3GPP), Technical Specification Group Services and System Aspects of Management and orchestration, Artificial Intelligence/Machine Learning (AI/ML) management”, the specifications related to the IE as discussed above may be described as below.

The IOC AIMLTrainingRequest represents the AI/ML model training request that is created by the AI/ML training MnS consumer.

### 7.3.2.2 Attributes

| | Support | | | | |
|---|---|---|---|---|---|
| Attribute name | Qualifier | isReadable | isWritable | isInvariant | isNotifyable |
| aIMLEntityId | M | T | T | F | T |
| candidateTraingDataSource | O | T | T | F | T |
| traingDataQualityScore | O | T | T | F | T |
| trainingRequestSource | M | T | T | F | T |
| requestStatus | M | T | T | F | T |
| expectedRuntimeContext | O | T | T | F | T |
| performanceRequirements | M | T | T | F | T |
| cancelRequest | O | T | T | F | T |
| suspendRequest | O | T | T | F | T |
| measurementDataCorrelationAnalytics | O | T | T | F | T |
| Attribute related to role | | | | | |

Change on Attributes of the AIMLTrainingRequest begins.

7.4.x MeasurementDataCorrelationAnalytics <<dataType>>

### 7.4.x.1 Definition

The MeasurementDataCorrelationAnalytics represents the measurement data correlation analytics for a given analytics (prediction). The attribute support the following:
The candidateCorrelatedMeasurementData provides the address(es) of the candidate correlated measurement data generated from MDCA activity. The generated measurement data list is normally much shorter than the full measurement data list.
The mDCAResult indicates the MDCA results, it may be SUCCESSFUL WITH_MD_GENERATED, FAILED DUE TO PERFORMANCE_IMPACT, or other failure results.
The modelPerformanceImpactTolarance indicates the MDCA performance requirement. It is a percentage which requires the performance impact of trained AIMLEntity with generated measurement data within the range of the performance trained with full measurement data. E.g., 5% means the model performance for the AIMLEntity trained with generated measurement data shall be no worse than 5% of the performance trained with full measurement data.
The mDCAPerformanceResult indicates the actual MDCA performance impact. It is a percentage which indicate the loss the model performance from trained AIMLEntity with generated measurement data comparison to the performance trained with full measurement data. E.g., 3% means the model performance for the AIMLEntity trained with generated measurement data is 3% worse than the performance trained with full measurement data.
If AIMLT MnS Function support producer initiated regular retraining (NC326335), the scheduledMDCA may be enabled. The candidateCorrelatedMeasurementData, mDCAPerformanceImpactResult will be updated if a better results achieved.
The scheduledMDCAFlag indicates if a scheduled MDCA is enabled or not. By default, it's False. When a scheduled MDCA is enabled, the scheduledMDCAFlag shall be set to True.

### 7.4.x.2 Attributes

| | Support | | | | |
|---|---|---|---|---|---|
| Attribute name | Qualifier | isReadable | isWritable | isInvariant | isNotifyable |
| candidateCorrelatedMeasurementData | CM | T | F | F | T |
| modelPerformanceImpactTolarance | M | T | T | F | T |
| mDCAResult | M | T | F | F | T |
| mDCAPerformanceImpactResult | O | T | F | F | T |
| scheduledMDCAFlag | O | T | T | F | T |
| scheduledMDCA | O | T | T | F | T |

7.4.x.3 Attribute constraints

| Name | Definition |
|---|---|
| candidateCorrelatedMeasurementData | Condition: The value of |
| Support Qualifier | mDCAResult attribute is |
| | SUCCESSFUL_WITH_{—} |
| | MD_GENERATED. |

### 7.4.x.4 Notifications

The notifications specified for the IOC using this <<dataType>> for its attribute(s), shall be applicable.

7.4.y scheduledMDCA <<data Type>>

### 7.4.y.1 Definition

The scheduledMDCA represents the regularly performing measurement data correlation analytics, including correlation analytics activity status, cycle, etc. The scheduledMDCA may support the following attributes:
correlationAnalyticsCycle indicates how frequent the MDCA activity shall be performed, e.g., every weekly, or monthly.
optionally MnS consumer may indicate when to start the scheduled MDCA with attribute startTime, e.g., start the MDCA in middle-night to balance the computing load.
schedulingStatus indicates the status of current scheduledMDCA:
   RUNNING indicate the scheduled MDCA activity is ongoing or a new round of MDCA activity will be started as scheduled.
   SUSPENDED indicates no further new round of MDCA will be started. If a scheduled MDCA is in progress, all the following rounds of MDCA activity will not be started.

To be noted, the status of ProgressStatus shall be “RUNNING”. When the status is not “RUNNING”, the schedulingStatus is not defined and scheduled MDCA shall be stopped.

### 7.4.y.2 Attributes

| | Support | | | | |
|---|---|---|---|---|---|
| Attribute name | Qualifier | isReadable | isWritable | isInvariant | isNotifyable |
| correlationAnalyticsCycle | M | T | T | F | F |
| startTime | O | T | T | F | F |
| schedulingStatus | M | T | T | F | F |

7.4.y.3 Attribute constraints

None.

### 7.4.y.4 Notifications

The notifications specified for the IOC using this <<dataType>> for its attribute(s), shall be applicable.

### 7.3.5.2 Attributes

| | Support | | | | |
|---|---|---|---|---|---|
| | Qualifier | isReadable | isWritable | isInvariant | isNotifyable |
| Attribute name | | | | | |
| aIMLTrainingProcessId | M | T | T | F | T |
| priority | M | T | T | F | T |
| terminationConditions | M | T | T | F | T |
| progressStatus | M | T | F | F | T |
| cancelProcess | O | T | T | F | T |
| suspendProcess | O | T | T | F | T |
| scheduledMDCA | CM | T | T | F | T |
| Attribute related to role | | | | | |
| trainingRequestRef | CM | T | F | F | T |
| trainingReportRef | M | T | F | F | T |

7.3.5.3 Attribute constraints

| Name | Definition |
|---|---|
| trainingRequestRef | Condition: The AIMLTrainingReport MOI |
| Support Qualifier | represents the report for the AI/ML model training |
| | that was requested by the training MnS consumer |
| | (via AIMLTrainingRequest MOI). |
| scheduledMDCA | Condition: scheduled MDCA is supported |
| Support Qualifier | |

To be noted, instead of using AIMLTrainingProcess directly, alternative solution would be to define a new IOC, MDCARequest, and add the same data type of MeasurementDataCorrelationAnalytics as the attributes to the IOC. Same procedure with similar behaviour may be defined to achieve same function.

In some example embodiments, in the case that the solution for measurement data optimization is implemented in 3GPP communication systems, in “the 3rd Generation Partnership Project (3GPP), Technical Specification Group Services and System Aspects of Management and orchestration, Study on measurement data collection to support RAN intelligence”, the specifications related to the IE as discussed above may be described as below.

### 5.x Measurement Data Correlation Analysis

### 5.x.1 Description

The collected measurement data for an analytics use case may be often highly correlated (linearly or non-linearly). It would be enough (minimum and controlled impact to model performance) to well train an ML model if we could select only those input data features that are clearly correlated with the target data feature to predict, while the correlations between the input data features are low. Therefore, there are a lot of the data features not needed for the training and the inference of a given ML model.

5.x.2 Use cases
5.x.2.1 Regularly Renew the measurement data correlation analytics

Due to the complexity and time-varying nature of network, the measurement data collected can be highly correlated (linear or non-linear), using all measurement data for model training (and inference) is a waste of computing resource. Hence there is a need to have a solution:
For a give task (analytics), to analyze the correlation among the given set of all measurement data, the output is much smaller set of measurement data
Optionally and regularly renew the correlation analytics since as the time progresses the correlation relationship might change.
   5.x.3 Potential requirements

| | | Related |
|---|---|---|
| Requirement | | use |
| label | Description | case(s) |
| REQ-AIML_{—} | the 3GPP management system shall have | TBC |
| MDCA-CON-a | a capability for an authorized consumer | |
| | (e.g. an AIMLT function) to analyze the | |
| | correlation of measurement data for a | |
| | given analytics. | |
| REQ-AIML_{—} | The AIML MnS producer shall have the | TBC |
| MDCA-CON-b | capability of allowing an authorized | |
| | AIML MnS consumer to request for | |
| | scheduled re-analysis the correlation | |
| | of measurement data | |
| REQ-AIML_{—} | The AIML MnS producer shall have the | TBC |
| REMDCA- | capability of allowing an authorized | |
| CON-c | AIML MnS consumer to manage the | |
| | scheduled re-analysis the correlation | |
| | of measurement data, e.g, | |
| | To suspend an ongoing scheduled | |
| | MDCA activity, | |
| | To resume a suspended scheduled | |
| | MDCA activity, | |
| | To cancel a scheduled MDCA activity, | |
| | To configure the cycle of MDCA activity. | |

### 5.9.2.y-1: Potential Requirements

It would be appreciated that the above description proposed in the communication specifications is provided as examples and changes may be made to the description without departing from the scope of example embodiments of the present disclosure.

### Example Methods

FIG. 5 shows a flowchart of an example method 500 implemented at a first device in accordance with some example embodiments of the present disclosure. For the purpose of discussion, the method 500 will be described from the perspective of the first device 210 in FIG. 2.

At block 510, the first device 210 receives, from a second device (e.g., the second device 220 in FIG. 2), a request for input-output correlation analytics with respect to a data analytics task.

At block 520, in response to the request, the first device 210 performs the input-output correlation analytics on a set of measurement inputs and a target output of the data analytics task.

At block 530, the first device 210 transmits, to the second device, a response indicating a result of the input-output correlation analytics.

In some example embodiments, the request for input-output correlation analytics is received in association with a request for training a machine learning model for implementing the data analytics task.

In some example embodiments, the result of the input-output correlation analytics indicates at least one of the following: a set of recommended measurement inputs for the data analytics task that are determined from input-output correlation analytics as having a correlation higher than a threshold with the target output, or a success or failure result of the input-output correlation analytics.

In some example embodiments, the request for input-output correlation analytics further indicates a performance impact tolerance of the data analytics task. In some example embodiments, the result of the input-output correlation analytics indicates a resulting performance impact by replacing the set of measurement inputs with the set of recommended measurement inputs as input of the tata analytics task, the resulting performance impact being within the performance impact tolerance.

In some example embodiments, the request for input-output correlation analytics further indicates a scheduling status of regular input-output correlation analytics. In some example embodiments, performing the input-output correlation analytics comprises: in accordance with a determination that the scheduling status indicates enablement of regular input-output correlation analytics, performing regular input-output correlation analytics according to a predetermined cycle; and in accordance with a determination that the scheduling status indicates disablement of regular input-output correlation analytics, performing one round of the input-output correlation analytics.

In some example embodiments, the method 500 further comprises: in accordance with receipt of a suspending request for the regular input-output correlation analytics from the second device, suspending the regular input-output correlation analytics; in accordance with receipt of a resuming request for the regular input-output correlation analytics from the second device, resuming the suspended regular input-output correlation analytics; and in accordance with receipt of a terminating request for the regular input-output correlation analytics from the second device, terminating the regular input-output correlation analytics.

In some example embodiments, the method 500 further comprises: in accordance with a determination that the regular input-output correlation analytics is suspended, resumed, or terminated, transmitting, to the second device, a notification indicating that the regular input-output correlation analytics is suspended, resumed, or terminated.

In some example embodiments, the request for input-output correlation analytics comprises a controlling information element, the controlling information element being configurable with at least one of the following: a first attribute to indicate enablement or disablement of regular input-output correlation analytics, a second attribute to indicate a true or false status of regular input-output correlation analytics, a third attribute to indicate a performance impact tolerance of the data analytics task, a fourth attribute to indicate a success or failure result of the input-output correlation analytics, a fifth attribute to indicate a set of recommended measurement inputs correlated to the target output, or a sixth attribute to indicate a resulting performance impact by applying the set of recommended measurement inputs for the data analytics task. In some example embodiments, at least one of the first, second, and third attributes is assigned with a respective attribute value in the controlling information element comprised in the request for input-output correlation analytics.

In some example embodiments, the first attribute to indicate enablement or disablement of regular input-output correlation analytics further comprises at least one of the following: a first sub-attribute to indicate cycle of the regular input-output correlation analytics, a second sub-attribute to indicate a start time of the regular input-output correlation analytics, or a third sub-attribute to indicate a scheduling status of the regular input-output correlation analytics, the scheduling status being selected from a running status or a suspended status.

In some example embodiments, transmitting the response indicating the result of the input-output correlation analytics comprises: assigning a respective attribute value to at least one of the fourth, fifth, and sixth attributes of the controlling information element based on the result of the input-output correlation analytics; and transmitting the controlling information element to the second device.

In some example embodiments, the first device comprises an entity for a managed service producer, and the second service comprises an entity for a managed service consumer.

In some example embodiments, the managed service producer comprises a managed service producer for the data analytics task or a managed service producer for the measurement data analytics.

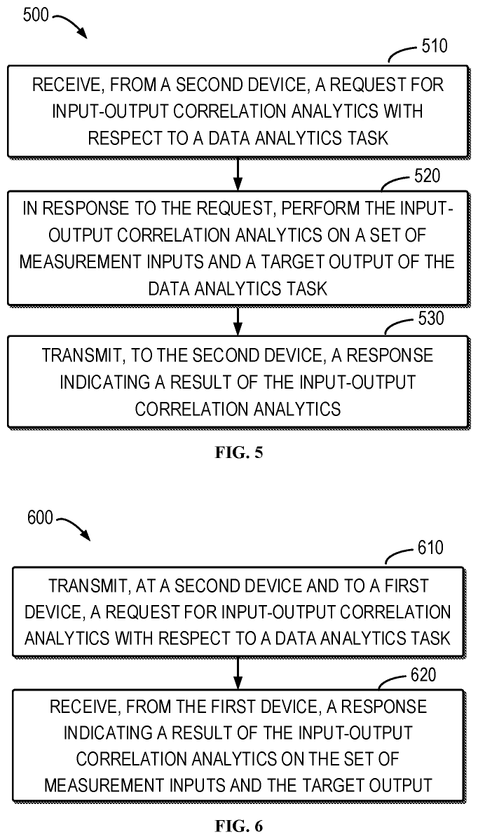

FIG. 6 shows a flowchart of an example method 600 implemented at a second device in accordance with some example embodiments of the present disclosure. For the purpose of discussion, the method 600 will be described from the perspective of the second device 220 in FIG. 2.

At block 610, the second device 220 transmits, to a first device (e.g., the first device 210 in FIG. 2), a request for input-output correlation analytics with respect to a data analytics task, the data analytics task being configured with a set of measurement inputs as input and to generate a target output.

At block 620, the second device 220 receives, from the first device, a response indicating a result of the input-output correlation analytics on the set of measurement inputs and the target output.

In some example embodiments, the request for input-output correlation analytics is received in association with a request for training a machine learning model for implementing the data analytics task.

In some example embodiments, the result of the input-output correlation analytics indicates at least one of the following: a set of recommended measurement inputs for the data analytics task that are determined from input-output correlation analytics as having a correlation higher than a threshold with the target output, or a success or failure result of the input-output correlation analytics.

In some example embodiments, the request for input-output correlation analytics further indicates a performance impact tolerance of the data analytics task. In some example embodiments, the result of the input-output correlation analytics indicates a resulting performance impact by replacing the set of measurement inputs with the set of recommended measurement inputs as input of the tata analytics task, the resulting performance impact being within the performance impact tolerance.

In some example embodiments, the request for input-output correlation analytics further indicates a scheduling status of regular input-output correlation analytics, the scheduling status indicating enablement or disablement of regular input-output correlation analytics.

In some example embodiments, the method 600 further comprises: transmitting, to the first device, one of the following requests: a suspending request to suspend the regular input-output correlation analytics, a resuming request to resume the regular input-output correlation analytics, or a terminating request to terminate the regular input-output correlation analytics.

In some example embodiments, the method 600 further comprises: receiving, from the first device, a notification indicating that the regular input-output correlation analytics is suspended, resumed, or terminated.

In some example embodiments, the request for input-output correlation analytics comprises a controlling information element, the controlling information element being configurable with at least one of the following: a first attribute to indicate enablement or disablement of regular input-output correlation analytics, a second attribute to indicate a true or false status of regular input-output correlation analytics, a third attribute to indicate a performance impact tolerance of the data analytics task, a fourth attribute to indicate a success or failure result of the input-output correlation analytics, a fifth attribute to indicate a set of recommended measurement inputs correlated to the target output, or a sixth attribute to indicate a resulting performance impact by applying the set of recommended measurement inputs for the data analytics task. In some example embodiments, the at least one of the first, second, and third attributes is assigned with a respective attribute value in the request for input-output correlation analytics.

In some example embodiments, the first attribute to indicate enablement or disablement of regular input-output correlation analytics further comprises at least one of the following: a first sub-attribute to indicate cycle of the regular input-output correlation analytics, a second sub-attribute to indicate a start time of the regular input-output correlation analytics, or a third sub-attribute to indicate a scheduling status of the regular input-output correlation analytics, the scheduling status being selected from a running status or a suspended status.

In some example embodiments, receiving the response indicating the result of the input-output correlation analytics comprises: receiving the controlling information element from the first device, at least one of the fourth, fifth, and sixth attributes of the controlling information element being assigned with a respective attribute value based on the result of the input-output correlation analytics.

In some example embodiments, the first device comprises an entity for a managed service producer, and the second service comprises an entity for a managed service consumer.

In some example embodiments, the managed service producer comprises a managed service producer for the data analytics task or a managed service producer for the measurement data analytics.

### Example Apparatuses, Devices and Medium

In some example embodiments, a first apparatus capable of performing any of the method 800 (for example, the first device 210 in FIG. 2) may comprise means for performing the respective operations of the method 800. The means may be implemented in any suitable form. For example, the means may be implemented in a circuitry or software module. The first apparatus may be implemented as or included in the first device 210 in FIG. 2.

In some example embodiments, the first apparatus comprises means for receiving, from a second apparatus, a request for input-output correlation analytics with respect to a data analytics task; means for, in response to the request, performing the input-output correlation analytics on a set of measurement input s and a target output of the data analytics task; and means for transmitting, to the second apparatus, a response indicating a result of the input-output correlation analytics.

In some example embodiments, the request for input-output correlation analytics is received in association with a request for training a machine learning model for implementing the data analytics task.

In some example embodiments, the result of the input-output correlation analytics indicates at least one of the following: a set of recommended measurement inputs for the data analytics task that are determined from input-output correlation analytics as having a correlation higher than a threshold with the target output, or a success or failure result of the input-output correlation analytics.

In some example embodiments, the request for input-output correlation analytics further indicates a performance impact tolerance of the data analytics task. In some example embodiments, the result of the input-output correlation analytics indicates a resulting performance impact by replacing the set of measurement inputs with the set of recommended measurement inputs as input of the tata analytics task, the resulting performance impact being within the performance impact tolerance.

In some example embodiments, the request for input-output correlation analytics further indicates a scheduling status of regular input-output correlation analytics. In some example embodiments, the means for performing the input-output correlation analytics comprises: means for, in accordance with a determination that the scheduling status indicates enablement of regular input-output correlation analytics, performing regular input-output correlation analytics according to a predetermined cycle; and means for, in accordance with a determination that the scheduling status indicates disablement of regular input-output correlation analytics, performing one round of the input-output correlation analytics.

In some example embodiments, the first apparatus further comprises: means for, in accordance with receipt of a suspending request for the regular input-output correlation analytics from the second apparatus, suspending the regular input-output correlation analytics; means for, in accordance with receipt of a resuming request for the regular input-output correlation analytics from the second apparatus, resuming the suspended regular input-output correlation analytics; and means for, in accordance with receipt of a terminating request for the regular input-output correlation analytics from the second apparatus, terminating the regular input-output correlation analytics.

In some example embodiments, the first apparatus further comprises: means for, in accordance with a determination that the regular input-output correlation analytics is suspended, resumed, or terminated, transmitting, to the second apparatus, a notification indicating that the regular input-output correlation analytics is suspended, resumed, or terminated.

In some example embodiments, the request for input-output correlation analytics comprises a controlling information element, the controlling information element being configurable with at least one of the following: a first attribute to indicate enablement or disablement of regular input-output correlation analytics, a second attribute to indicate a true or false status of regular input-output correlation analytics, a third attribute to indicate a performance impact tolerance of the data analytics task, a fourth attribute to indicate a success or failure result of the input-output correlation analytics, a fifth attribute to indicate a set of recommended measurement inputs correlated to the target output, or a sixth attribute to indicate a resulting performance impact by applying the set of recommended measurement inputs for the data analytics task.

In some example embodiments, at least one of the first, second, and third attributes is assigned with a respective attribute value in the controlling information element comprised in the request for input-output correlation analytics.

In some example embodiments, the first attribute to indicate enablement or disablement of regular input-output correlation analytics further comprises at least one of the following: a first sub-attribute to indicate cycle of the regular input-output correlation analytics, a second sub-attribute to indicate a start time of the regular input-output correlation analytics, or a third sub-attribute to indicate a scheduling status of the regular input-output correlation analytics, the scheduling status being selected from a running status or a suspended status.

In some example embodiments, the means for transmitting the response indicating the result of the input-output correlation analytics comprises: means for assigning a respective attribute value to at least one of the fourth, fifth, and sixth attributes of the controlling information element based on the result of the input-output correlation analytics; and transmitting the controlling information element to the second apparatus.

In some example embodiments, the first apparatus comprises an entity for a managed service producer, and the second service comprises an entity for a managed service consumer.

In some example embodiments, the managed service producer comprises a managed service producer for the data analytics task or a managed service producer for the measurement data analytics.

In some example embodiments, a second apparatus capable of performing any of the method 900 (for example, the second device 220 in FIG. 2) may comprise means for performing the respective operations of the method 900. The means may be implemented in any suitable form. For example, the means may be implemented in a circuitry or software module. The second apparatus may be implemented as or included in the second device 220 in FIG. 2.

In some example embodiments, the second apparatus comprises means for transmitting, to a first apparatus, a request for input-output correlation analytics with respect to a data analytics task, the data analytics task being configured with a set of measurement inputs as input and to generate a target output; and means for receiving, from the first apparatus, a response indicating a result of the input-output correlation analytics on the set of measurement inputs and the target output.

In some example embodiments, the request for input-output correlation analytics is received in association with a request for training a machine learning model for implementing the data analytics task

In some example embodiments, the result of the input-output correlation analytics indicates at least one of the following: a set of recommended measurement inputs for the data analytics task that are determined from input-output correlation analytics as having a correlation higher than a threshold with the target output, or a success or failure result of the input-output correlation analytics.

In some example embodiments, the request for input-output correlation analytics further indicates a performance impact tolerance of the data analytics task. In some example embodiments, the result of the input-output correlation analytics indicates a resulting performance impact by replacing the set of measurement inputs with the set of recommended measurement inputs as input of the tata analytics task, the resulting performance impact being within the performance impact tolerance.

In some example embodiments, the request for input-output correlation analytics further indicates a scheduling status of regular input-output correlation analytics, the scheduling status indicating enablement or disablement of regular input-output correlation analytics.

In some example embodiments, the second apparatus further comprises: means for transmitting, to the first apparatus, one of the following requests: a suspending request to suspend the regular input-output correlation analytics, a resuming request to resume the regular input-output correlation analytics, or a terminating request to terminate the regular input-output correlation analytics.

In some example embodiments, the second apparatus further comprises: receiving, from the first apparatus, a notification indicating that the regular input-output correlation analytics is suspended, resumed, or terminated.

In some example embodiments, the request for input-output correlation analytics comprises a controlling information element, the controlling information element being configurable with at least one of the following: a first attribute to indicate enablement or disablement of regular input-output correlation analytics, a second attribute to indicate a true or false status of regular input-output correlation analytics, a third attribute to indicate a performance impact tolerance of the data analytics task, a fourth attribute to indicate a success or failure result of the input-output correlation analytics, a fifth attribute to indicate a set of recommended measurement inputs correlated to the target output, or a sixth attribute to indicate a resulting performance impact by applying the set of recommended measurement inputs for the data analytics task. In some example embodiments, the at least one of the first, second, and third attributes is assigned with a respective attribute value in the request for input-output correlation analytics.

In some example embodiments, the first attribute to indicate enablement or disablement of regular input-output correlation analytics further comprises at least one of the following: a first sub-attribute to indicate cycle of the regular input-output correlation analytics, a second sub-attribute to indicate a start time of the regular input-output correlation analytics, or a third sub-attribute to indicate a scheduling status of the regular input-output correlation analytics, the scheduling status being selected from a running status or a suspended status.

In some example embodiments, the means for receiving the response indicating the result of the input-output correlation analytics comprises: means for receiving the controlling information element from the first apparatus, at least one of the fourth, fifth, and sixth attributes of the controlling information element being assigned with a respective attribute value based on the result of the input-output correlation analytics.

In some example embodiments, the first apparatus comprises an entity for a managed service producer, and the second service comprises an entity for a managed service consumer.

In some example embodiments, the managed service producer comprises a managed service producer for the data analytics task or a managed service producer for the measurement data analytics.

In some example embodiments, the second apparatus further comprises means for performing other operations in some example embodiments of the method 900 or the second device 220. In some example embodiments, the means comprises at least one processor; and at least one memory storing instructions that, when executed by the at least one processor, cause the performance of the second apparatus.

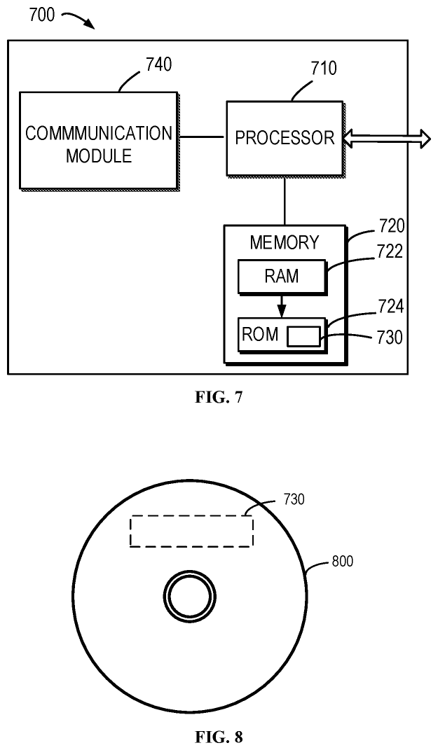

FIG. 7 is a simplified block diagram of a device 700 that is suitable for implementing example embodiments of the present disclosure. The device 700 may be provided to implement, for example, the first device 210 or the second device 220 as shown in FIG. 2. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 2 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provides at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory storing instructions that, when executed by the at least one processor, cause the first device at least to perform:
receiving, from a second device, a request for input-output correlation analytics with respect to a data analytics task;
in response to the request, performing the input-output correlation analytics on a set of measurement inputs and a target output of the data analytics task; and
transmitting, to the second device, a response indicating a result of the input-output correlation analytics.

2. The first device of claim 1, wherein the request for input-output correlation analytics is received in association with a request for training a machine learning model for implementing the data analytics task.

3. The first device of claim 1- or 2, wherein the result of the input-output correlation analytics indicates at least one of the following:
a set of recommended measurement inputs for the data analytics task that are determined from input-output correlation analytics as having a correlation higher than a threshold with the target output, or
a success or failure result of the input-output correlation analytics.

4. The first device of claim 3, wherein the request for input-output correlation analytics further indicates a performance impact tolerance of the data analytics task, and
wherein the result of the input-output correlation analytics indicates a resulting performance impact by replacing the set of measurement inputs with the set of recommended measurement inputs as input of the tata analytics task, the resulting performance impact being within the performance impact tolerance.

5. The first device of claim 1, wherein the request for input-output correlation analytics further indicates a scheduling status of regular input-output correlation analytics, and
wherein performing the input-output correlation analytics comprises:
in accordance with a determination that the scheduling status indicates enablement of regular input-output correlation analytics, performing regular input-output correlation analytics according to a predetermined cycle; and
in accordance with a determination that the scheduling status indicates disablement of regular input-output correlation analytics, performing one round of the input-output correlation analytics.

6. The first device of claim 5, further comprising:
in accordance with receipt of a suspending request for the regular input-output correlation analytics from the second device, suspending the regular input-output correlation analytics;
in accordance with receipt of a resuming request for the regular input-output correlation analytics from the second device, resuming the suspended regular input-output correlation analytics; and
in accordance with receipt of a terminating request for the regular input-output correlation analytics from the second device, terminating the regular input-output correlation analytics.

7. The first device of claim 6, further comprising:
in accordance with a determination that the regular input-output correlation analytics is suspended, resumed, or terminated, transmitting, to the second device, a notification indicating that the regular input-output correlation analytics is suspended, resumed, or terminated.

8. The first device of claim 1, wherein the request for input-output correlation analytics comprises a controlling information element, the controlling information element being configurable with at least one of the following:
a first attribute to indicate enablement or disablement of regular input-output correlation analytics,
a second attribute to indicate a true or false status of regular input-output correlation analytics,
a third attribute to indicate a performance impact tolerance of the data analytics task,
a fourth attribute to indicate a success or failure result of the input-output correlation analytics,
a fifth attribute to indicate a set of recommended measurement inputs correlated to the target output, or
a sixth attribute to indicate a resulting performance impact by applying the set of recommended measurement inputs for the data analytics task, and
wherein at least one of the first, second, and third attributes is assigned with a respective attribute value in the controlling information element comprised in the request for input-output correlation analytics.

9. The first device of claim 8, wherein the first attribute to indicate enablement or disablement of regular input-output correlation analytics further comprises at least one of the following:
a first sub-attribute to indicate cycle of the regular input-output correlation analytics,
a second sub-attribute to indicate a start time of the regular input-output correlation analytics, or
a third sub-attribute to indicate a scheduling status of the regular input-output correlation analytics, the scheduling status being selected from a running status or a suspended status.

10. The first device of claim 8, wherein transmitting the response indicating the result of the input-output correlation analytics comprises:
assigning a respective attribute value to at least one of the fourth, fifth, and sixth attributes of the controlling information element based on the result of the input-output correlation analytics; and
transmitting the controlling information element to the second device.

11. The first device of claim 1, wherein the first device comprises an entity for a managed service producer, and the second service comprises an entity for a managed service consumer.

12. The first device of claim 10, wherein the managed service producer comprises a managed service producer for the data analytics task or a managed service producer for the measurement data analytics.

13. A second device comprising:
at least one processor; and
at least one memory storing instructions that, when executed by the at least one processor, cause the second device at least to perform:
transmitting, to a first device, a request for input-output correlation analytics with respect to a data analytics task, the data analytics task being configured to analyze a set of measurement inputs to generate a target output; and
receiving, from the first device, a response indicating a result of the input-output correlation analytics on the set of measurement inputs and the target output.

14. The second device of claim 13, wherein the request for input-output correlation analytics is received in association with a request for training a machine learning model for implementing the data analytics task.

15. The second device of claim 13, wherein the result of the input-output correlation analytics indicates at least one of the following:
a set of recommended measurement inputs for the data analytics task that are determined from input-output correlation analytics as having a correlation higher than a threshold with the target output, or
a success or failure result of the input-output correlation analytics.

16. The second device of claim 15, wherein the request for input-output correlation analytics further indicates a performance impact tolerance of the data analytics task, and
wherein the result of the input-output correlation analytics indicates a resulting performance impact by replacing the set of measurement inputs with the set of recommended measurement inputs as input of the tata analytics task, the resulting performance impact being within the performance impact tolerance.

17. The second device of claim 13, wherein the request for input-output correlation analytics further indicates a scheduling status of regular input-output correlation analytics, the scheduling status indicating enablement or disablement of regular input-output correlation analytics.

18. The second device of claim 17, further comprising:
transmitting, to the first device, one of the following requests:
a suspending request to suspend the regular input-output correlation analytics,
a resuming request to resume the regular input-output correlation analytics, or
a terminating request to terminate the regular input-output correlation analytics.

19. The second device of claim 18, further comprising:
receiving, from the first device, a notification indicating that the regular input-output correlation analytics is suspended, resumed, or terminated.

20. The second device of claim 13, wherein the request for input-output correlation analytics comprises a controlling information element, the controlling information element being configurable with at least one of the following:
a first attribute to indicate enablement or disablement of regular input-output correlation analytics,
a second attribute to indicate a true or false status of regular input-output correlation analytics,
a third attribute to indicate a performance impact tolerance of the data analytics task,
a fourth attribute to indicate a success or failure result of the input-output correlation analytics,
a fifth attribute to indicate a set of recommended measurement inputs correlated to the target output, or
a sixth attribute to indicate a resulting performance impact by applying the set of recommended measurement inputs for the data analytics task, and
wherein the at least one of the first, second, and third attributes is assigned with a respective attribute value in the request for input-output correlation analytics.

21-29. (canceled)
